(19) United States
(12) Patent Application Publication
(10) Pub. No.: US 2002/0080444 A1
(43) Pub. Date: Jun. 27, 2002

(54) Multiple access system for communications network

(76) Inventors: David Phillips, Bishops Stortford (GB); Michael F. Grant, Bishops Stortford (GB); Frank E. Lockwood, Raleigh, NC (US)

Correspondence Address: William M. Lee, Jr., LEE, MANN, SMITH, MCWILLIAMS, SWEENEY & OHLSON, P.O. Box 2786, Chicago, IL, 60690-2786, US

(21) Appl. No.: 09/747,692

(22) Filed: Dec. 22, 2000

(51) Int. Cl. H04J 14/02; H04B 10/00

(52) U.S. Cl. 359/125; 359/168

(57) ABSTRACT

A communications access network comprising a combination of fibre and co-axial cable to the home having co-axial cable deployed in the home comprises a head end, to which outstations are coupled via an optical fibre medium incorporating a star coupler or splitter. The head end is arranged to transmit downstream to the outstations a sequence of frames comprising data frames and command frames. The command frames comprise first and second frames and provide marshalling control of upstream transmissions from the outstations. The first command frame incorporates a global command to all outstations to pause upstream transmission for a pre-set time period. The second command frame is transmitted within the pre-set period and incorporates a further pause command having an associated zero time period and addressed to a selected outstation overriding said global command thus allowing that one selected outstation to transmit to the head end.

### FIELD OF THE INVENTION

The present invention relates to access networks and to methods of carrying traffic over such networks

### BACKGROUND OF THE INVENTION

Traditional access networks, servicing residential and small business customers have typically employed optical fibre transmissions to a head end from which customers are served via local distribution units. In the past, cabling between a given local distribution unit and outstations located at residences or places of business of customers (known as a “final drop”) has comprised co-axial cables and twisted pair copper loops. In many cases the co-axial cables have been installed for Radio Frequency (RF) services, for example television, and the copper loops have previously been installed for telephony purposes. A single fibre connection links the head end to optoelectronic devices at the given local distribution unit for converting optical signals to electrical signals, for example, a photo-diode. The photo-diode is coupled to an amplifier and an electrical splitter for coupling the co-axial cables between the electrical splitter and the outstations. Downlink information is then broadcast from the given local distribution units to the outstations. However, the bandwidth of traditional access networks is severely restricted by the use of co-axial cables used as the final drop.

More recently introduced systems employ optical transmission paths between the head end and the distribution units, and there is now an incentive to extend the optical transmission path to the final drop so as to provide Fibre To The Home (FTTH), where the fibre connection is terminated at equipment which is either external or internal residences/places of business. Such a configuration has the advantage of overcoming the severe bandwidth limitations of the co-axial cables and the copper loops by replacing the co-axial cables and the copper loops with a broadband optical path. However, in some areas of the network, the final drop comprises an unused optical transmission path along with an electrical transmission path in the form of co-axial cables and copper loops, the optical transmission path being for subsequent switch-over from the co-axial cable and the twisted-pair loop to the optical transmission path. Additionally, co-axial cables and twisted pair loops are used to propagate signals between terminals located at the residences or places of business of customers and so the co-axial cables and twisted-pair loops are coupled to the outstations and limit available bandwidth between the terminals and the head end.

In a typical passive optical network providing FTTH, the head end or central office is typically located at a local point of presence of a network operator associated with the passive optical network, and is connected to a number of outstations via a fibre network. A single fibre connection links the head end to a passive optical splitter at the given local distribution unit which divides the optical power equally between a number of fibres, each of which is coupled to the passive optical splitter and terminates at a respective outstation. Signals sent downstream from the head end arrive at a reduced power level at all outstations. Each outstation converts the optical signal (carrying information) to an electrical signal and decodes the information. The information includes addressing information which identifies which components of the information flow are intended for a particular outstation. In the upstream direction, each outstation is allocated a time interval during which it is permitted to impress an optical signal on the upstream fibre. The fibres from all outstations are combined at the optical splitter and pass over the common fibre link to the head end. Signals sourced from any outstation propagate only to the head end. The upstream network can use separate fibre links and splinters, or can use the same network as the downstream direction but using a different optical wavelength. A protocol for organising traffic to and from each outstation, known as the FSAN (Full Service Access Network, IEEE specification G.983.1), protocol, has been introduced for this purpose.

Typically, the propagation delay of the optical paths between the head end and each outstation will differ. To prevent collisions on the upstream path, the protocol must allow for this, either by creating a guard band between transmission opportunities for different outstations, or by causing each outstation to build out the optical path delay to a common value by adding delay in the electrical domain. This latter approach has been adopted by FSAN.

FSAN is a relatively complex protocol, requiring large scale integrated circuit technology in a practical system. Such integrated circuits are specialised for the PON application and are therefore costly because of the relatively small volumes used.

A further disadvantage of the FSAN protocol is that it employs asynchronous transfer mode (ATM) transport of traffic. Most, if not all, of this traffic will be Internet Protocol (IP) packet traffic. These IP packets are of variable length, and can be as long as about 1500 bytes. Adaptation of this packet traffic into fixed length ATM cells requires the provision of interfaces for segmentation and subsequent reassembly of the IP packets. This requirement adds further to the cost and complexity of the installed system.

### SUMMARY OF THE INVENTION

According to a first aspect of the present invention, there is provided a communications network comprising a head end coupled by respective communications paths to a plurality of outstations, wherein the head end has means for marshalling upstream communications from the plurality of outstations via the transmission of downstream commands, the downstream commands comprising a global command allowing none of the outstations to transmit to the head end for a pre-set period, the global command being followed within the pre-set period by a further command to a selected outstation of the plurality of outstations overriding said global command allowing the selected outstation to transmit upstream to the head end, wherein at least one of the respective communications paths comprises an optical communication path portion and an electrical path portion.

A Carrier Sense Multiple Access/Collision Detect (CSMA/CD) protocol may be employed for upstream communications over the electrical path portion.

Preferably, the further command to the selected outstation to commence transmission upstream comprises a pause command to the selected outstation to pause transmission upstream for a zero time period.

Preferably, the head end is coupled to the at least one of the plurality of outstations via a star coupler.

Preferably, the head end is coupled to at least one of the plurality of outstations via an optoelectronic conversion unit. The optoelectronic conversation unit may comprise a photo-diode and an amplifier. Additionally or alternatively, the optoelectronic conversion unit may comprise a laser-diode and an amplifier.

Preferably, different optical wavelengths are used respectively for upstream and downstream transmission along the optical communication path. More preferably, downstream transmissions from the head end are carried on a plurality of optical wavelengths.

According to a second aspect of the present invention, there is provided a communications access network comprising, a head end, and a plurality of outstations coupled to the head end via a propagation medium, wherein the head end is arranged to transmit downstream to the plurality of outstations a sequence of frames comprising data frames and command frames, wherein the command frames comprise first and second command frames and provide marshalling control of upstream transmission from the plurality of outstations, wherein the first command frame incorporates a global command to all of the plurality of outstations to pause upstream transmission for a pre-set time period, and wherein the second command frame is transmitted within the pre-set lime period and incorporates a further pause command having an associated zero time period, the further pause command addressed to a selected outstation overriding the global command and allowing the selected outstation to transmit to the head end, wherein the propagation medium comprises an optical medium portion and an electrical medium portion.

Preferably, the head end is coupled to at least one of the plurality of outstations by a star coupler. More preferably, said star coupler is a non-return coupler.

Preferably, the head end is coupled to at least one of the plurality of outstations by a splitter.

According to a third aspect of the present invention, there is provided a communications network comprising a head end coupled by respective communications paths to a plurality of outstations, wherein the head end is arranged to transmit downstream to the plurality of outstations information frames containing data traffic and command frames for marshalling upstream transmissions from the plurality of outstations, wherein alternate command frames contain respectively, a global command to all of the plurality of outstations to pause upstream transmission for a pre-set time period, and a further command addressed to a selected outstation overriding the global command and allowing the selected outstation to transmit upstream to the head end.

According to a fourth aspect of the present invention, there is provided a method of marshalling upstream communications from a plurality of outstations to a head end in a communications network, the head end being coupled to the plurality of outstations by respective communications paths and at least one of the respective communications paths comprises an optical communications path portion and an electrical path portion, the method comprising: sending from the head end to the plurality of outstations a global command allowing none of the plurality of outstations to transmit to the head end for a pre-set period, and within the pre-set time period, sending a further command to a selected outstation overriding the global command allowing the selected outstation to transmit to the head end.

Preferably, the further command comprises a pause command to the selected outstation and having a zero time period associated therewith.

According to a fifth aspect of the present invention, there is provided a method of marshalling upstream communications to a head end from a plurality of outstations in a communications network, the head end being coupled to the plurality of outstations by respective communications paths and at least one of the respective communications paths comprises an optical communications path portion and an electrical path portion, the method comprising transmitting downstream, from the head end to the plurality of outstations data frames and command frames, wherein alternate command frames contain respectively, a global command to all of the plurality of outstations to pause upstream transmission for a pre-set time period, and a further command transmitted within the pre-set time period to a selected outstation overriding the global command allowing the selected outstation to transmit to the head end.

Preferably, the global command to all of the plurality of outstations to pause transmission is accompanied by a broadcast address.

Preferably, each of the outstations has a respective address, and wherein the further command to the selected outstation to commence transmission is accompanied by the address of the selected outstation.

Preferably, the further command to the selected outstation to commence transmission upstream comprises a pause command to the selected outstation to pause upstream transmission for a zero time period.

Preferably, different optical wavelengths are employed for respective downstream and upstream transmission along the optical communication path.

According to a sixth aspect of the present invention, there is provided computer executable software code stored on a computer readable medium, the code being for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising: code to send from the head end to the plurality of outstations a global command allowing none of the plurality of outstations to transmit to the head end for a pre-set period, and code to send within the pre-set time period, a further command to a selected outstation overriding the global command allowing the selected outstation to transmit to the head end.

According to a seventh aspect of the present invention, there is provided a programmed computer for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising: a memory having at least one region for storing computer executable program code, and a processor for executing the program code stored in the memory, wherein the program code comprises: code to send from the head and to the plurality of outstations a global command allowing none of the plurality of outstations to transmit to the head end for a pre-set period, and code to send, within the pre-set time period, a further command to a selected outstation overriding the global command allowing the selected outstation to transmit to the head end.

According to an eighth aspect of the present invention, there is provided a computer readable medium having computer executable code stored thereon, the code being for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising: code to send from the head end to the plurality of outstations a global command allowing none of the plurality of outstations to transmit to the head end for a pre-set period, and code to send, within the pre-set time period, a further command to a selected outstation overriding the global command allowing the selected outstation to transmit to the head end.

The above apparatus and method has the particular advantage of providing a hybrid fibre-coax connection to the home access network. An existing final drop between the local distribution unit and an outstation can be retained. The final drop may consist of co-axial cable and/or twisted-pair metallic loop coupled between terminals and the outstation. Additionally, the above apparatus and method also enables the use, if required, of a FTTH access network in the form of a Passive Optical Network (PON) so as to avoid the need to provide a prior co-axial final drop from the local distribution unit to the outstations, whilst enabling use of existing co-axial cabling coupled to the outstation at the residence or place of business of the customer. It should be noted this technique has features in common with Ethernet, but it will be observed that whereas Ethernet is an established protocol used in computer local area networks this technique is concerned with operation over neighbourhoods with significantly different characteristics. Moreover, current implementations of Gigabit Ethernet (GbE) use point to point optical links to a “switching hub” at a logical hub of an Ethernet. The switching hub demodulates incoming signals from the point to point links and directs traffic to one or more output channels. The disadvantage with this current implementation is that it requires active electronics and an associated power supply in the switching hub which is not compatible with operator requirements to remove active electronics from street locations.

In a preferred embodiment of the invention, a protocol is employed to control point to multi-point communication over the hybrid coaxial cable-optical fibre network so as to prevent collision or contention of upstream communications from customer terminals to the system head end. We have found that the adaptation of Gigabit Ethernet technology to operate over a shared access hybrid coaxial cable-optical fibre network provides significant cost advantages over an FSAN PON. Furthermore, since an increasing proportion of network traffic is based on the IP, which typically requires relatively long packets, further cost savings accrue by avoiding the packet segmentation and re-assembly processes that are required to make use of the short packet structure of the FSAN PON.

Ethernet (including GbE) includes an optional flow control facility, intended to restrict the amount of traffic being sent to a node when the node is not in a position to process the incoming information. When this situation arises, the node sends to its peer a “PAUSE control frame” Control frames take priority over queued data frames and the PAUSE control frame is transmitted as soon as any current data frame transmission has finished. The PAUSE control frame contains a data value representing a time interval. On receipt, the peer node completes transmission or any current frame but then waits for the specified time interval before restarting transmissions. The header of the PAUSE control frame carries an address field and a type indicator field which identify to the peer the frame type. The operation of this flow control system is detailed in IEEE standard 802.3 Annex 31B “MAC Control PAUSE Operation”.

Advantageously, we make use of large scale integrated circuits designed for the Gigabit Ethernet protocol, but using a point to multi-point hybrid coaxial cable-optical fibre network instead of the point to point network for which the circuits were designed in the downstream direction. Traffic from a Gigabit Ethernet Media Access Controller (MAC) is broadcast to all outstations via an optical to electrical conversion unit and the interconnecting optical fibres. Each outstation MAC recognises traffic intended for locally connected equipment by matching the destination address carried in the header of downstream frames. In the upstream direction, each outstation employs a GbE MAC to generate upstream traffic. To prevent multiple outstations transmitting simultaneously, PAUSE control frames are used to allocate “permission to transmit” to each outstation in turn. This enables successful decoding at the system head end. Each outstation is allocated a portion of the total traffic capacity. In a further embodiment, the capacity allocated to each outstation can be varied depending on its specified quality of service or actual need.

The invention also provides for a system for the purposes of digital signal processing which comprises one or more instances of apparatus embodying the present invention, together with other additional apparatus.

### BRIEF DESCRIPTION OF THE DRAWINGS

At least one embodiment of the invention will now be described, by way of example only, with reference to the accompanying figures, in which:

FIG. 1 is a schematic diagram of a hybrid coaxial cable-passive optical access network constituting an embodiment of the invention;

FIG. 2 is a schematic diagram of a passive optical access network (PON) constituting another embodiment of the present invention;

FIG. 3 is a flow chart illustrating a use of a multiple access algorithm in the networks of FIGS. 1 and 2 to marshal upstream transmissions;

FIG. 4 is a schematic diagram of a structure of a downstream data frame, and

FIG. 5 is a schematic diagram of a structure of a downstream command or PAUSE frame.

### DETAILED DESCRIPTION OF PREFERRED EMBODIMENTS

Throughout the following description, identical reference numerals will be used to identify like parts.

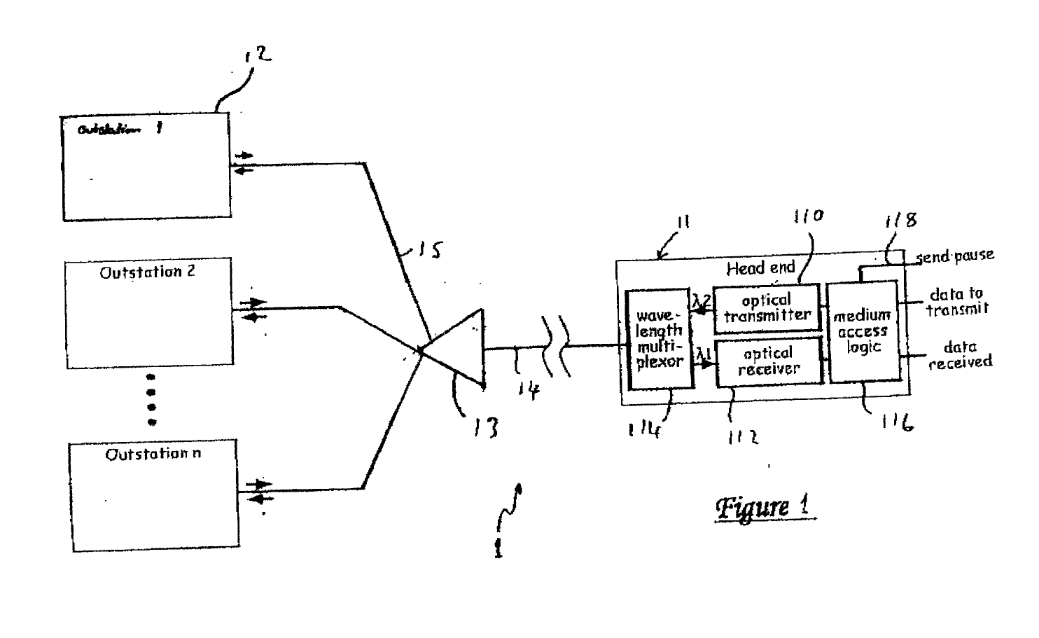

Referring to FIG. 1, a hybrid co-axial cable-passive optical access network 1 comprises a head end 11 coupled to an optoelectronic conversion unit 13, for example, a photo-diode (not shown) coupled to a first amplifier (not shown). The optoelectronic conversion unit 13 also comprises a second amplifier (not shown) and a laser diode (not shown). The optical-to-electrical conversion unit 13 is coupled to a respective outstation 12 by a respective co-axial cable 15 constituting a respective final drop. The respective co-axial cable 15 is then coupled to at least one communications terminal (not shown) coupled to the respective outstation 12.

In the network illustrated, downstream and upstream traffic use the same fibres and splitter, but each direction uses a different optical wavelength. Optionally, the network can use separate fibres and splitters for each direction of transmission.

The head end 11 comprises an optical transmitter 110, typically a laser, operating at a first wavelength λ₁, and an optical receiver 112 operating at a second wavelength λ₂. The optical transmitter and receiver 110, 112 are coupled to the fibre 14 via a wavelength multiplexer 114 so as to provide bi-directional optical transmission.

The optical transmitter and receiver 110, 112 are electrically coupled to a control logic circuit 116, the control logic circuit 116 providing an interface with an external network (not shown) to receive data to be transmitted downstream to the outstations 12 and to transmit to the external network upstream data received from the outstations 12.

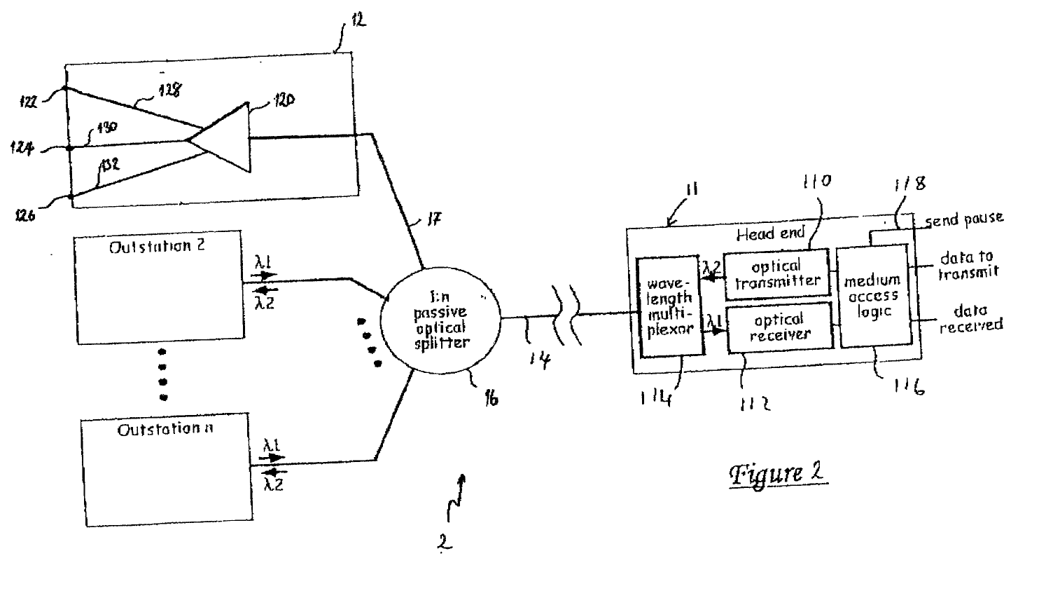

Referring to FIG. 2, an exemplary FTTH access network 2 comprises the head end 11 connected to a number of outstations 12 through a 1:n passive optical splitter 16 via the optical fibre paths 14 and respective optical fibre 17. Typically, the distance from the head end 11 to the splitter 16 is up to around 5 km. The distance between any two outstations is assumed to be relatively small, typically about 500 m. The splitter 16 is located at a convenient point in a street where the outstations 12 are located In the network illustrated, downstream and upstream traffic use the same fibres and splitter, but each direction uses a different optical wavelength. Optionally, the network can use separate fibres and splitters for each direction of transmission.

The head end 11 comprises the optical transmitter 110, typically the laser, operating at the first wavelength λ₁, and the optical receiver 112 operating at the second wavelength λ₂. The optical transmitter and receiver 110, 112 are coupled to the fibre 14 via the wavelength multiplexer 114 so as to provide bi-directional optical transmission.

The optical transmitter and receiver 110, 112 are electrically coupled to the control logic circuit 116, the control logic circuit 116 providing the interface with an external network (not shown) to receive data to be transmitted downstream to the outstations 12 and to transmit to the external network upstream data received from the outstations 12.

Each outstation comprises an optoelectronic conversion unit 120 for conversion of electrical signals to optical signals and vice versa. The optoelectronic conversion unit 120 is coupled to a first outstation output terminal 122, a second outstation terminal 124 and a third outstation output terminal 126 by a first co-axial cable 128, a second co-axial cable 130 and third co-axial cable 132, respectively. An input terminal (not shown) of the optoelectronic conversion unit 120 is coupled to fibre 17.

Since the optical path between an outstation and the head end passes through the splitter 16 in each direction, the optical transmission path has higher loss than in a simple point to point arrangement. To compensate for this transmission loss, the head end can be equipped with a powerful laser transmitter 110 and a sensitive receiver 112.

In the examples of FIGS. 1 and 2, the outstation electronics or electro-optics are based on standard Gigabit Ethernet modules to minimise cost and to minimise the risk of danger from eye exposure at the customer premises.

Referring to both FIGS. 1 and 2, a hardware connection or send PAUSE input 118 is provided to the head end control or MAC logic from which transmission of a PAUSE frame can be initiated. This function could also be achieved by software access to an internal control register (not shown).

For the purpose of simplicity and clarity of description, operation of the apparatus of FIG. 1 will only be described. However, the apparatus of FIG. 2 operates in an analogous manner, except that references to outstations and parts of outstations should be replaced by references to terminals and coupled outstations located at the home or place of business of the customer.

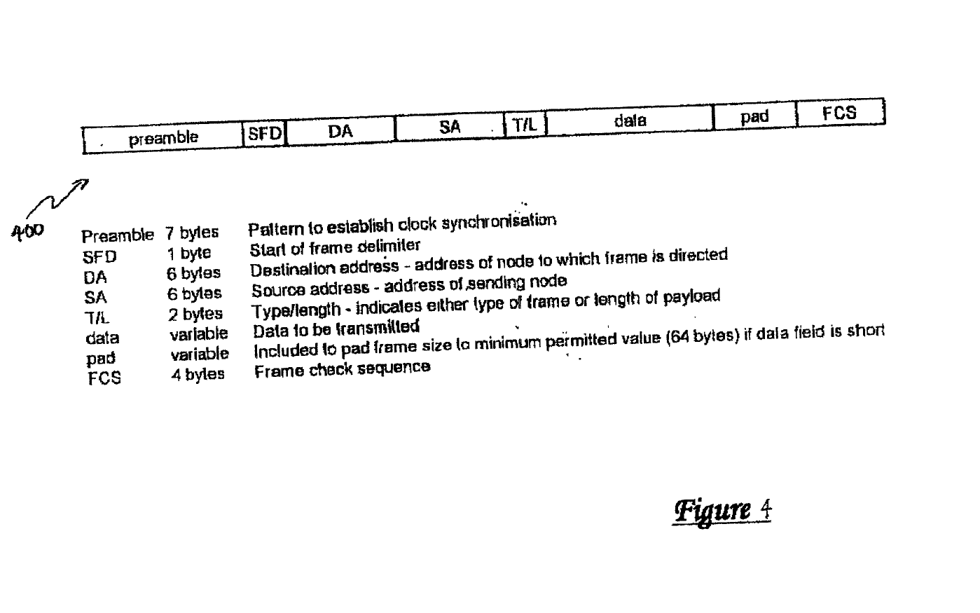

In operation, information frames sent by the head end optical transmitter 110 are broadcast to all outstations 12 via the optoelectronic conversion unit 13 or the optical splitter 16 as standard Ethernet frames. The standard Ethernet frames are generated and communicated in accordance with IEEE 802.3§3.1.1 “MAC Frame Format”, §34.3.1 “MAC Control Frame Format”, §31.4.1.3 “MAC Control-Type/Length Field”, IEEE 802.3 Annex 31A “MAC Control Opcode Assignments” and Annex 31B “MAC Control PAUSE Operation” The structure of a typical information frame 400, as illustrated in FIG. 4, comprises a preamble, a start of frame delimiter (SFD), a destination address (DA) of the outstation 12 for which the message is intended, and a data payload (data). The frame also includes the source address (SA) of the sending node, a type/length field (T/L) indicating either the frame type or the payload length, and a frame check sequence. The payload can also include padding (pad) if the data length is insufficient to fill the payload space.

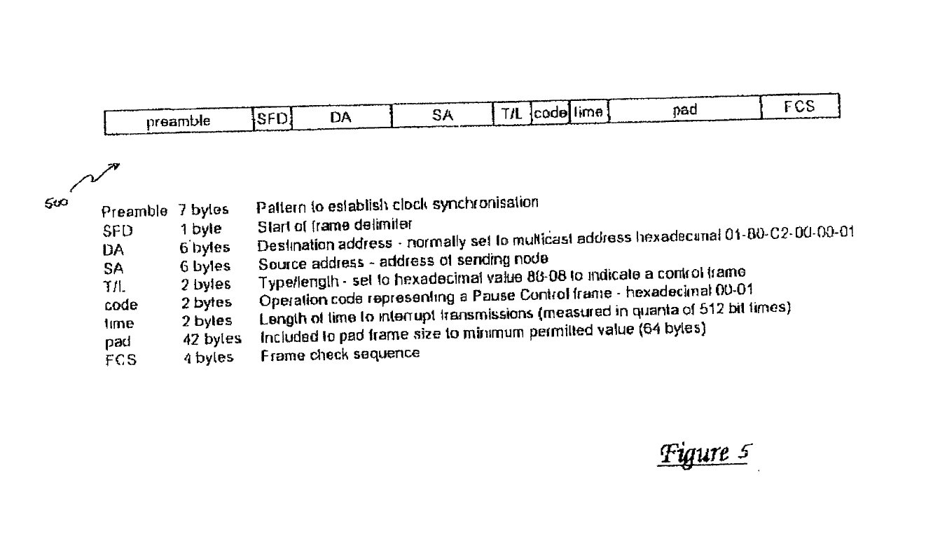

Periodically, the information frames are interspersed with PAUSE control frames generated under control of the head end 11. Referring to FIG. 5, the PAUSE frame structure 500 is similar to that of the data frame described above with the exception that the type/length field (T/L), which is set to a value indicative of a control frame, is followed by a code field representing a PAUSE command and a time field denoting the length of the PAUSE. The specified PAUSE time can be a pre-set value or zero, and PAUSE frames sent before a previously specified PAUSE time has expired cause any outstanding time interval to be over-ridden.

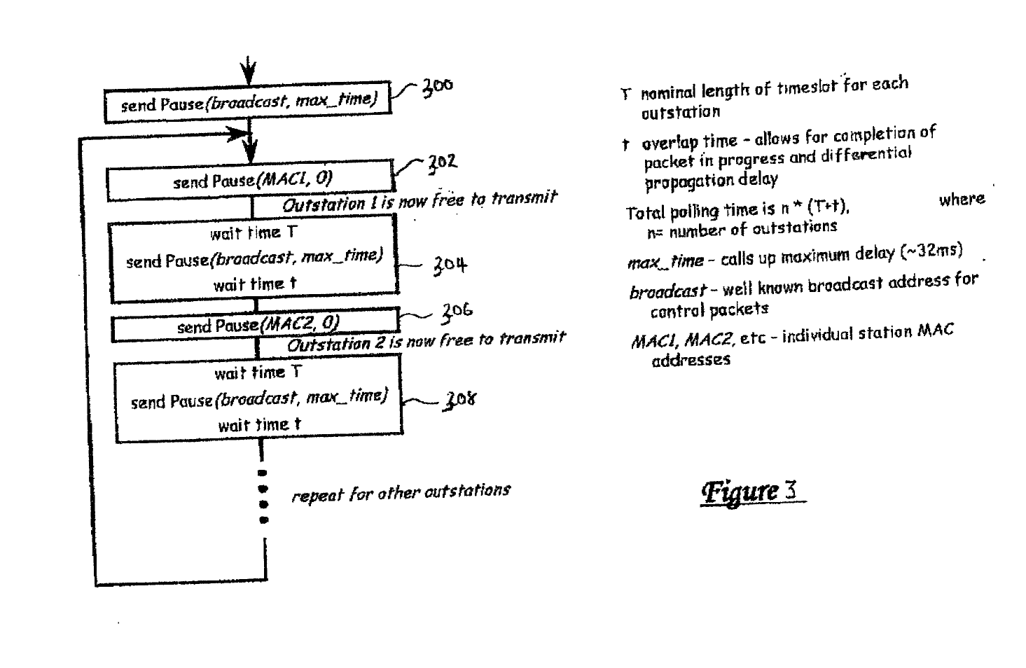

The PAUSE mechanism is used herein as a means to achieve marshalling and interleaving of upstream transmissions from the outstations connected to the passive splitter. All outstations are, in principle, able to transmit simultaneously. This is prevented by sending a global PAUSE command to all outstations. Referring to FIG. 3, this can be done by generating (step 300) a PAUSE frame containing a well known broadcast address and specifying a “long” time interval, where “long” represents a value which will cause any outstation to cease transmission for a time period that is longer than the desired active slot time for any outstation. The head end 11 allows a “guard time” which is long enough to ensure that any frame which is already being transmitted has time to complete and upstream signals already on the medium propagate beyond the splitter point. The head end 11 then issues (step 302) a next pause command containing the individual MAC address of that one of the outstations 12 to be allowed to transmit, and specifying a PAUSE time of zero. This overrides the previous PAUSE command for that outstation 12 and causes any frames queued at the selected outstation 12 to be sent on the medium and subsequently received at the head end 11. Transmissions from other outstations are inhibited because of the unexpired PAUSE time from the previous PAUSE command. Following the desired active slot time, the head end 11 again issues (step 304) a global PAUSE command and the process repeats (steps 300 and 302) for each of the remaining outstations Effectively, the head end 11 issues in alternate time periods global PAUSE commands which allow no outstation 12 to transmit to the head end 11, and individual PAUSE commands which allow one selected outstation 12 to transmit to the head end 11. Advantageously, the method steps illustrated in FIG. 3 can be carried out via a processor programmed with software instructions.

Several elements contribute to the guard time (t) that is required to prevent potential collisions. These elements include uncertainty in the launch time of the downstream PAUSE frame 500, because the downstream PAUSE frame 500 must wait for completion of any data frame 400 already started. There is also uncertainty in the time at which transmission from an active outstation will cease, again, because it must wait for completion of any data frame 400 in progress. There is also the differential propagation delay between outstations 12 and the resynchronisation time when accepting traffic from different outstations 12.

The total time to interrogate all outstations 12 is a compromise between the additional delay introduced by the multiple access mechanism and inefficiencies arising from the guard time (t). We have found for example that, in a network with eight outstations 12, an active slot time of 200 microseconds with a guard band of 50 microseconds leads to a total polling interval of 2 milliseconds and an efficiency of 80% relative to standard point to point full duplex Ethernet. A bounded polling interval together with a minimum guaranteed slot time allow traffic contracts based on specified quality of service.

Optionally, the length of each outstation's active time slot can be varied depending on the level of activity at that outstation 12 and its contracted quality of service. Outstations which have been inactive for a significant length of time may be polled less frequently until new activity is detected, for example, every 100 milliseconds, or longer if it is deemed that the outstation 12 has been turned off or disconnected. These enhancements increase efficiency at low load and allow unused traffic capacity to be reallocated to active outstations which can therefore achieve a higher burst rate.

In a conventional Gigabit Ethernet using a point to point protocol, each optical transmitter remains active even during gaps between frame transmissions, and during PAUSE intervals, when an “idle” pattern is transmitted to maintain clock synchronisation at the receiver. In the multiple access system descried herein, transmission of idle patterns during PAUSE intervals is suppressed to avoid interference with frame transmissions from the active outstation. A control of laser shutdown input 128 to turn off the transmitting laser in the outstation is shown in FIGS. 1 and 2 for this purpose. This control input can be driven either from real time software running in a node processor (not shown) of the outstation 12, or can be derived from additional hardware in the outstation 12.

When a new outstation is switched on and connected to the network 1, an optical transmitter (not shown) of the new outstation should be inhibited until the receive channel has an opportunity to synchronise with the downstream transmissions from the head end 11 so as to avoid corrupting timeslots allocated to other outstations 12 before receiving a global pause command from the head end 11.

In the example of FIG. 2, to increase the downstream capacity of the network 2, either initially or as an upgrade to an existing network, traffic in the downstream direction can use multiple wavelengths, each wavelength being detected at one or more outstations 12 using wavelength selective filters or couplers installed either in the outstations 12 or at the coupler site. In this way, an asymmetrical network is generated, having higher capacity in the downstream direction; PAUSE frames would be launched on all active wavelengths to ensure all outstations 12 receive timely PAUSE commands.

As discussed above, separate wavelengths are employed for upstream and downstream transmission to allow full duplex transmission where downstream and upstream transmissions are made concurrently on separate wavelengths. The network can then work in full duplex, where downstream transmissions take place concurrently with upstream.

Preferably, the network 1 uses a non-return star coupler as the splitter 13 at the hub. The construction of a suitable star coupler is described in our co-pending application (reference 124691D), the contents of which are incorporated herein by reference. A non-return coupler combines upstream optical transmissions from the outstations on to the optical fibre path 14 to the head end 11 whilst preventing observation of a given upstream transmission of a respective given outstation from any other outstations. In the downstream direction, the non-return coupler distributes optical transmissions from the head end 11 to all outstations 12. Optionally, the head end 11 can be connected to the star coupler using a single optical fibre (instead of a fibre pair) by adding wavelength multiplexers at each end of the fibre connection.

Any range of device value given herein may be extended or altered without losing the effect sought, as will be apparent to the skilled person for an understanding of the teachings herein.

Alternative embodiments of the invention can be implemented as a computer program product for use with a computer system, the computer program product being, for example, a series of computer instructions stored on a tangible data recording medium, such as a diskette, CD-ROM, ROM, or fixed disk, or embodied in a computer data signal, the signal being transmitted over a tangible medium or a wireless medium, for example microwave or infrared. The series of computer instructions can constitute all or part of the functionality described above, and can also be stored in any memory device, volatile or non-volatile, such as semiconductor, magnetic, optical or other memory device.

1. A communications network comprising a head end coupled by respective communications paths to a plurality of outstations, wherein the head end has means for marshalling upstream communications from the plurality of outstations via the transmission of downstream commands, the downstream commands comprising a global command allowing none of the outstations to transmit to the head end for a pre-set period, the global command being followed within the pre-set period by a further command to a selected outstation of the plurality of outstations overriding said global command allowing the selected outstation to transmit upstream to the head end, wherein at least one of the respective communications paths comprises an optical communication path portion and an electrical path portion.

2. A communications network as claimed in claim 1, wherein the further command to the selected outstation to commence transmission upstream comprises a pause command to the selected outstation to pause transmission upstream for a zero time period.

3. A communications network as claimed in claim 1, wherein the head end is coupled to the at least one of the plurality of outstations via a star coupler.

4. A communications network as claimed in claim 1, wherein the head end is coupled to at least one of the plurality of outstations via an optical-to-electrical conversion unit.

5. A communications network as claimed in claim 4, wherein the optical-to-electrical conversation unit comprises a photo-diode and an amplifier.

6. A communications network as claimed in claim 3, wherein different optical wavelengths are used respectively for upstream and downstream transmission along the optical communication path.

7. A communications network as claimed in claim 6, wherein downstream transmissions from the head end are carried on a plurality of optical wavelengths.

8. A communications access network comprising, a head end, and a plurality of outstations coupled to the head end via a propagation medium, wherein the head end is arranged to transmit downstream to the plurality of outstations a sequence of frames comprising data frames and command frames, wherein the command frames comprise first and second command frames and provide marshalling control of upstream transmission from the plurality of outstations, wherein the first command frame incorporates a global command to all of the plurality of outstations to pause upstream transmission for a pre-set time period, and wherein the second command frame is transmitted within the pre-set time period and incorporates a further pause command having an associated zero time period, the further pause command addressed to a selected outstation overriding the global command and allowing the selected outstation to transmit to the head end, wherein the propagation medium comprises an optical medium portion and an electrical medium portion.

9. A communications network as claimed in claim 8, wherein the head end is coupled to at least one of the plurality of outstations by a star coupler.

10. A communications network as claimed in claim 9, wherein said star coupler is a non-return coupler.

11. A communications network as claimed in claim 8, wherein the head end is coupled to at least one of the plurality of outstations by a splitter.

12. A communications network comprising a head end coupled by respective communications paths to a plurality of outstations, wherein the head end is arranged to transmit downstream to the plurality of outstations information frames containing data traffic and command frames for marshalling upstream transmissions from the plurality of outstations, wherein alternate command frames contain respectively, a global command to all of the plurality of outstations to pause upstream transmission for a pre-set time period, and a further command addressed to a selected outstation overriding the global command and allowing the selected outstation to transmit upstream to the head end.

13. A method of marshalling upstream communications from a plurality of outstations to a head end in a communications network, the head end being coupled to the plurality of outstations by respective communications paths and at least one of the respective communications paths comprises an optical communications path portion and an electrical path portion, the method comprising:
sending from the head end to the plurality of outstations a global command allowing none of the plurality of outstations to transmit to the head end for a pre-set period, and
within the pre-set time period, sending a further command to a selected outstation overriding the global command allowing the selected outstation to transmit to the head end.

14. A method as claimed in claim 13, wherein the further command comprises a pause command to the selected outstation and having a zero time period associated therewith.

15. A method of marshalling upstream communications to a head end from a plurality of outstations in a communications network, the head end being coupled to the plurality of outstations by respective communications paths and at least one of the respective communications paths comprises an optical communications path portion and an electrical path portion, the method comprising transmitting downstream, from the head end to the plurality of outstations data frames and command frames, wherein alternate command frames contain respectively, a global command to all of the plurality of outstations to pause upstream transmission for a pre-set time period, and a further command transmitted within the pre-set time period to a selected outstation overriding the global command allowing the selected outstation to transmit to the head end.

16. A method as claimed in claim 15, wherein the global command to all of the plurality of outstations to pause transmission is accompanied by a broadcast address.

17. A method as claimed in claim 16, wherein each of the outstations has a respective address, and wherein the further command to the selected outstation to commence transmission is accompanied by the address of the selected outstation.

18. A method as claimed in claim 17, wherein the further command to the selected outstation to commence transmission upstream comprises a pause command to the selected outstation to pause upstream transmission for a zero time period.

19. A method as claimed in claim 15, wherein different optical wavelengths are employed for respective downstream and upstream transmission along the optical communication path.

20. Computer executable software code stored on a computer readable medium, the code being for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising:
code to send from the head end to the plurality of outstations a global command allowing none of the plurality of outstations to transmit to the head end for a pre-set period, and
code to send, within the pre-set time period, a further command to a selected outstation overriding the global command allowing the selected outstation to transmit to the head end.

21. A programmed computer for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising:
a memory having at least one region for storing computer executable program code, and
a processor for executing the program code stored in the memory, wherein the program code comprises:
code to send from the head end to the plurality of outstations a global command allowing none of the plurality of outstations to transmit to the head end for a pre-set period, and
code to send, within the pre-set time period, a further command to a selected outstation overriding the global command allowing the selected outstation to transmit to the head end.

22. A computer readable medium having computer executable code stored thereon, the code being for marshalling upstream communications from a plurality of outstations to a head end in a communications network, the head end being coupled to the plurality of outstations by respective communications paths and at least one of the respective communications paths comprising an optical communications path portion and an electrical communications path portion, the code comprising:
code to send from the head end to the plurality of outstations a global command allowing none of the plurality of outstations to transmit to the head end for a pre-set period, and
code to send, within the pre-set time period, a further command to a selected outstation overriding the global command allowing the selected outstation to transmit to the head end.
